(19) United States
(12) Patent Application Publication
(10) Pub. No.: US 2011/0200404 A1
(43) Pub. Date: Aug. 18, 2011

(54) SPIRAL TAP

(75) Inventors: Kentarou Norimatsu, Toyokawa-shi (JP); Takayuki Nakajima, Toyokawa-shi (JP)

(73) Assignee: OSG CORPORATION, Toyokawa-shi, Aichi (JP)

(21) Appl. No.: 13/123,829

(22) PCT Filed: Oct. 27, 2008
(86) PCT No.: PCT/JP2008/069477

§ 371 Date: Apr. 12, 2011

(51) Int. Cl. B23G 5/06

(52) U.S. Cl. 408/224; 408/230

(57) ABSTRACT

A spiral tap is disclosed having a thread portion having an external thread, spiral flutes which is fluted in the same direction as a cutting/rotating direction, as seen in a direction away from a shank side, to divide the external thread, and cutting edges formed along the spiral flutes; the thread portion including a full thread portion having a fixed outer diameter, and a chamfer portion decreasing in outer diameter toward a tap end; the chamfer portion being screwed into a prepared hole to cut an internal thread on an inner circumferential wall of the prepared hole and to discharge chips along the spiral flutes toward the shank; the chamfer portion having an external thread with screw threads which is formed such that outer circumferential portions are removed, at a linear line for cutting as seen from a direction perpendicular to a cross-section involving an axis O, from the screw threads having the same dimension as that of the full thread portion; and the linear line intersecting the axis O at an inclined angle θ falling in a range of −15°≦θ≦30′ with a side decreasing in diameter toward the tap end being defined positive.

### TECHNICAL FIELD

The present invention relates to spiral taps and, more particularly, to a technology of improving a screw thread configuration of a chamfer portion with a view to improving chip discharging performance and durability of a cutting edge.

### BACKGROUND ART

A spiral tap has been widely used with a structure including (a) a thread portion having an external thread, spiral flutes fluted in the same direction as a cutting/rotating direction as viewed from a shank to allow the external thread to be divided or segmented, and cutting edges formed along the spiral flutes. (b) The thread portion includes a full thread portion having a fixed outer diameter, and a chamfer portion decreasing in outer diameter to a tap end. (c) The spiral tap is screwed from the chamfer portion into a prepared hole to cut an inner circumferential periphery of the prepared hole into an internal thread, and to discharge chips the shank side via the spiral flutes. With such a spiral tap, it is usual practice to form the chamfer portion with the external thread having the screw threads formed in two ways. That is, for instance, outer circumferential portions of the screw threads, formed in the same dimension as those of the full thread portion, are cut out obliquely along a predetermined chamfering gradient to decrease in diameter toward the tap end, or a whole of the screw threads decreases in diameter toward the tap end along the chamfering gradient (see Patent Publication 1).

Patent Publication 1: Japanese Patent Application Publication No. 37-13848

### DISCLOSURE OF THE INVENTION

### Subject to be Addressed by the Invention

With the spiral tap of such a related art, however, a chip configuration, i.e., a cutting edge configuration, is specified in a screw thread configuration of the external thread and a slope caused by the chamfering gradient, or only the screw thread configuration. Therefore, it is likely that adequate performance cannot be necessarily obtained in chip discharging performance and durability of the cutting edges.

The present invention has been completed with the above view in mind and has an object to increase in chip discharging performance and durability of cutting edges by providing a chamfer portion with an external thread with an improved screw thread configuration.

### Means for Solving the Subject

For achieving the above object, in a first aspect of the present invention is related to a spiral tap comprising (a) a thread portion having an external thread, spiral flutes which is fluted in the same direction as a cutting/rotating direction, as seen in a direction away from a shank side, to divide the external thread, and cutting edges formed along the spiral flutes; (b) the thread portion including a full thread portion having a fixed outer diameter, and a chamfer portion decreasing in outer diameter toward a tap end; and (c) the chamfer portion being screwed into a prepared hole to cut an internal thread on an inner circumferential wall of the prepared hole and to discharge chips along the spiral flutes toward the shank; the spiral tap being characterized in that (d) the chamfer portion has an external thread with screw threads which is formed such that outer circumferential portions are removed, at a linear line for cutting as seen from a direction perpendicular to a cross-section involving an axis O, from the screw threads having the same dimension as that of the full thread portion; and (e) the linear line intersects the axis O at an inclined angle θ falling in a range of −15°≦θ≦30′ with a side decreasing in diameter toward the tap end being defined positive.

In a second aspect of the invention, the chamfer portion has a plurality of screw threads, contiguous in the axial direction, which have outer diameters varying with a predetermined fixed chamfering gradient according to the first aspect of the present invention.

In a third aspect of the invention, the chamfer portion has a plurality of screw threads, contiguous in the axial direction, which have outer diameters varying to have a concaved shape in the axial direction according to the first aspect of the present invention.

### EFFECT OF THE INVENTION

As used herein, the term “inclined angle θ of the linear line” refers to an inclined angle between the linear line and the axis O of the outer circumferential surface of the screw thread of the external thread i.e., male thread of the chamfer portion, and represents the inclined angle between the axis O of the outer circumferential portion and the cutting edge formed on a ridge area where the screw thread and the spiral flute intersect each other. Internal thread cutting work tests to check chip discharging performance and durability of cutting edges were conducted using spiral taps with chamfer whose inclined angles θ are determined independently of a chamfering gradient. As a result, it is turned out that with the chamfer falling in the inclined angle θ of −15°≦θ≦30′, where a side decreasing in diameter toward the tap end is defined positive, a favorable effect was obtained. That is, a chip had a further stable helical shape with resultant capability of favorably discharging the chip from the spiral flutes than that achieved with the spiral tap of the related art or conventional art (screw threads having outer circumferential portions being cut out on an oblique line along a chamfering gradient). This results in the suppression of chipping of the cutting edge due to biting of the chips for thereby providing improved durability.

According to the tests conducted by the present inventors, further, when the inclined angle θ is selected in the value expressed as −15°≦θ≦30′ tapping torque was slightly increased. However it is still in an allowable range where processing can be achieved. A thrust force was nearly equal to that achieved with the tap of the related art.

With a second aspect of the present invention, the chamfer may preferably have a plurality of screw threads, axially contiguous, which have outer diameters varying along a predetermined fixed chamfering gradient. Therefore, cutting dimensions of a large number of cutting edges present on the chamfer, i.e., dimensions in thickness of the chips are nearly equaled to each other. This allows a whole of the cutting edges of the chamfer to produce chips formed in stabilized helical shapes, resulting in a further increase in chip discharging performance.

With a third aspect of the present invention, the chamfer may preferably include a plurality of screw threads, contiguous in the axial direction, whose outer diameters vary as if the plurality of screw threads form a concaved shape in the axial direction. Therefore, a cutting dimension of the cutting edge, i.e., a thickness dimension of the chip, decreases along a direction from the full thread portion toward a tap end. With an area near the full thread portion, since a cutting operation is performed with the screw threads in the vicinity of apex portions, the chip has decreased dimension in width. With another area closer to the tap end, since the cutting is performed with the screw thread in the vicinity of a root thereof, the chip becomes large in width.

Thus the chips generated by the individual cutting edges, tend to vary in cross-sectional shapes of the chips such that the cross-sectional areas (further in volumes to be removed) of the chips are to be equalized to each other, in comparison to a case where the chamfer varies at the fixed chamfering gradient as achieved in the previous aspect of the invention mentioned above. This decreases a difference between cutting loads acting on the large number of cutting edges, thereby suppressing the occurrence of local wear accompanied with resultant further increased durability.

### BRIEF DESCRIPTION OF THE DRAWINGS

FIG. 1 is a set of views showing a spiral tap to which the present invention is applied; FIG. 1A is a front view; FIG. 1B represents an enlarged view in cross section taken on line IA-IA of FIG. 1A; and FIG. 1C is an enlarged view showing screw threads shapes formed at a chamfer.

FIG. 2 is a set of views showing the screw threads shapes of the chamfer of the spiral tap shown in FIG. 1; FIG. 2A is a view showing one example of a processing method; FIG. 2B is a view illustrating an inclined angle θ of an outer circumferential surface of a screw threads; and FIG. 2C is a view showing cutting-in shapes (chip shapes) of a large number of cutting edges of the chamfer.

FIG. 3 is a set of views illustrating a result obtained by a durability test conducted using test pieces of seven kinds different in inclined angle θ; FIG. 3A represents a processing condition; and FIG. 3B is a view representing the test result.

FIG. 4 is a photograph of a chip discharged during the durability test shown in FIG. 3 to represent a test piece No. 4 implementing the present invention.

FIG. 5 is a photograph of a chip discharged during the durability test shown in FIG. 3 to represent a test piece No. 1 of the related art.

FIG. 6 is a set of views showing data on rotating torque measured for initial three holes when subjected to the durability test of FIG. 3; FIG. 6A is a view showing data related to the test piece No. 4 of the present invention; and FIG. 6B is a view showing data related to the test piece No. 1 of the related art.

FIG. 7 is a set of views showing data on a thrust force measured for the initial three holes when subjected to the durability test of FIG. 3; FIG. 7A is a view showing data related to the test piece No. 4 of the present invention; and FIG. 7B is a view showing data related to the test piece No. 1 of the related art.

FIG. 8 is a view illustrating another embodiment according to the present invention and corresponding to FIG. 1C.

### EXPLANATION OF REFERENCES

| | | | |
|---|---|---|---|
| 10: spiral tap | 16: thread portion | 16a: full thread | |
| | | portion | |
| 16b: chamfer | 18: external thread | 20: spiral flutes | 22: cutting edges |
| portion | | | |
| ◯: center axis | θ: inclined angle | | |

### BEST MODE FOR CARRYING OUT THE INVENTION

Although a spiral tap, implementing the present invention, generally has two to four spiral flutes provided to allow an external thread to be divided, the number of spiral flutes may be suitably determined depending on a diametrical dimension or the like. In general, the spiral flutes have fluted angles falling in a range of approximately, for instance, 10° to 55°, and those of which fall in a range of approximately 30° to 50° have been widely in use. However, the fluted angles can be suitably determined depending on a diametrical dimension or the like. Although for base material, high-speed tool steel or cemented carbide steel may be preferably employed, the other tool materials may also be adopted. The spiral tap may be possibly applied with hard coating of TIN, TiCN or the like, or may be subjected to oxidation treatment depending on needs.

The spiral tap implementing the present invention may be used as an exclusive tool for cutting an internal thread i.e., female thread in a prepared hole preliminarily formed with a drill or the like. In an alternative, the spiral tap may have a structure with a drill or the like unitized to a tap end at a position remote from the thread portion to cut a prepared hole first and subsequently cut the internal thread therein. In another alternative, the spiral tap may be of the type that cuts an internal thread in a blind bore or of the type that cuts an internal thread in a through-bore.

Those of which chamfer portion has an axial dimension falling in a range of, for instance, about 1.5 P (where “P” is referred to as “a pitch of threads”) to 4 P are used in general. Those of which axial dimensions especially fall in a value of 2 P to 3 P have been widely known. However, the axial dimensions may be suitably determined depending on a diametric dimension and a kind of material which a workpiece is made of or the like.

An external thread of the chamfer portion has screw threads formed at an inclined angle θ that can be defined to be a target inclined angle θ by grinding and removing an outer circumferential portion of the external thread having the same dimension as that of, for instance, a full thread portion using a grindstone or the like. However, with the spiral tap finished under such a completed state, it may suffice for the inclined angle θ to fall in a value of −15°≦θ≦30′ and a method of such processing may be suitably determined. All of the screw threads divided with the spiral flutes may preferably fall in the same angle as the inclined angle θ, but the inclined angle θ may vary continuously or stepwise within a range of −15° to +30′.

If the inclined angle θ is less than −15° (with an increase in a negative phase), then, a corner portion of a cutting edge formed at a tap end decreases in angle (to be less than 105° with a screw thread having a crest angle of 60°), causing a risk of wear or chipping occurring to a cutting edge. On the contrary, if the inclined angle θ is greater than 30′, then, it becomes difficult to adequately obtain an effect of causing chips to have stable helical shape with increased discharging performance. Therefore, the inclined angle θ may be preferably determined within a range of −15° to +30′.

With a third aspect of the present invention, the chamfer portion has a plurality of screw threads axially contiguous so as to have outer diameters varying in a concaved shape along the axial direction. Thus, a cutting dimension of the cutting edge, i.e., a thickness dimension of the chip decreases from the full thread portion to the tap end. Therefore, chips generated by the individual cutting edges have cross-sectional surface areas with a minimized difference. The concaved shapes, i.e., the outer diameters of a large number of screw threads of the chamfer portion may be preferably determined such that the chips have cross-sectional surface areas nearly equal to each other.

### EMBODIMENTS

Hereunder, embodiments of the present invention will be described in detail with reference to the accompanying drawings.

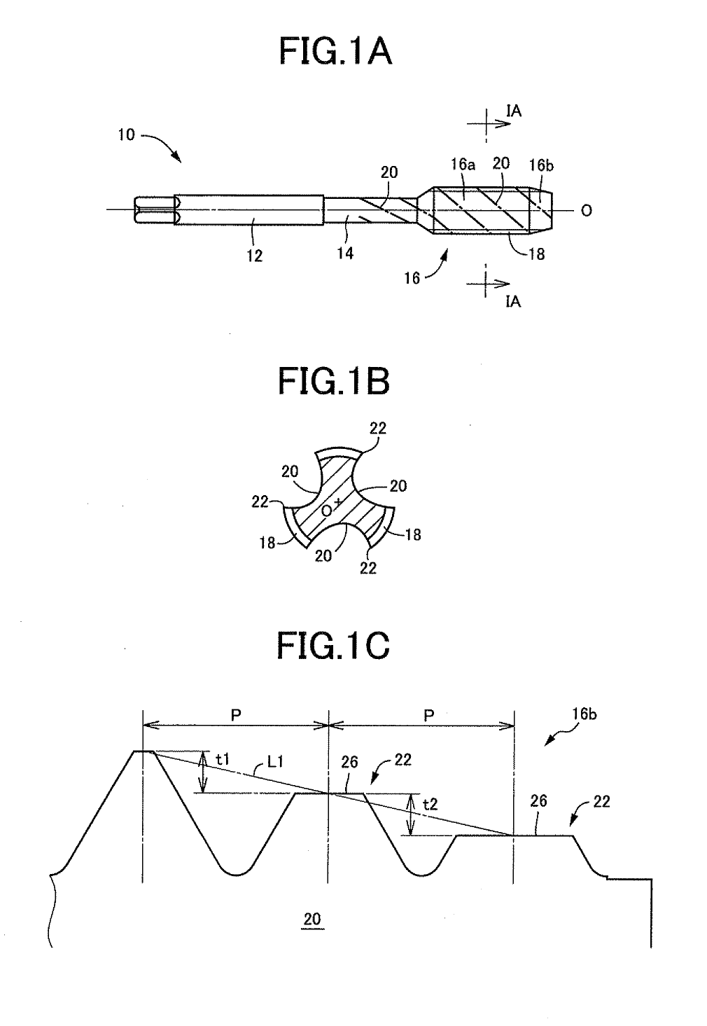

FIGS. 1A, 1B and 1C are a set of views showing a spiral tap 10, having three cutting edges, of one embodiment according to the present invention; FIG. 1A is a front view of the spiral tap 10 as viewed in a direction perpendicular to an axis “O”; and FIG. 1B is an enlarged view in cross section taken on line IA-IA of FIG. 1A; and FIG. 1C is a view showing screw threads profiles (cutting teeth profiles) of a chamfer 16b in an enlarged scale. The spiral tap 10 has a shank 12, a neck portion 14 and the thread portion 16, all of which are formed on a common axis in this order. The thread portion 16 has an external thread 18 having a groove profile corresponding to an internal thread to be cut. Further, the thread portion 16 has three spiral flutes 20, formed at circumferentially and equidistantly spaced intervals about the axis O, which are fluted in the same direction as a cutting/rotating direction as viewed from the shank 12 (i.e., clockwise in the present embodiment) to divide the external thread 18. The thread portion 16 includes a chamfer portion 16b, decreasing in outer diameter toward a tap end, and a full thread portion 16a continuously extending from the chamfer portion 16b to have a full thread formed in a fixed outer diameter. The thread portion 16 has cutting edges 22 formed along the spiral flutes 20. Each of the three spiral flutes 20 is continuously formed on the thread portion 16 and a midway of the neck portion 14 in series along a helix line with a fixed lead. Single-dot lines shown in FIG. 1A represent centerlines of the spiral flutes 20, respectively. With the present embodiment, the spiral tap 10 is made of high-speed tool steel and has a nominal designation of M12×1.75. Each spiral flute 20 of the thread portion 16 has a spiral angle of approximately 40° and the chamfer portion 16b has an axial length of 2.5 P (with “P” representing a pitch of threads).

With the chamfer portion 16b, a plurality of screw threads contiguous in the axial direction has an outer diameter varying at a fixed chamfering gradient that is predetermined. The screw threads are designed to have crests (outer circumferential surfaces 26) whose centers are aligned on a linear line L1 inclined at a chamfering gradient angle (of 13° 12′ in the present embodiment) with respect to the axis O. Variation t1 in outer diameter of the screw threads contiguous in the axial direction is equal to the variation t2 of another contiguous screw threads. The variations t1 and t2 in outer diameter correspond to cutting dimensions of the cutting edges 22, i.e., thickness dimensions of chips. With the present embodiment, the spiral tap 10 has three blades, that is, three arrays of cutting edges 22 formed around the axis O and a cutting dimension (representing the thickness dimension of each chip) of each cutting edge 22 is ⅓ of the variations t1 and t2.

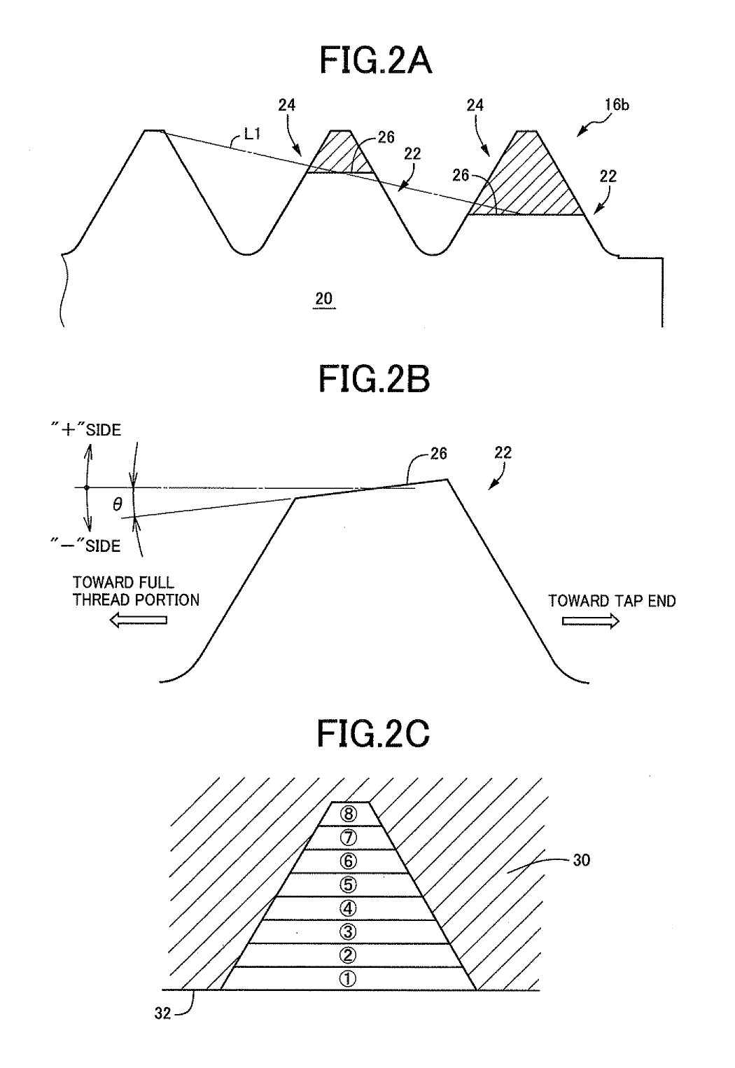

Further, the screw threads on the external thread of the chamfer portion 16b, are formed in shapes obtained by linearly cutting out outer circumferential portions (i.e., hatched areas in FIG. 2A) of the screw threads 24, having the same dimension as that of the full thread portion 16, in cross section including the axis O as shown in FIG. 2A. In the present embodiment, the screw threads 24 are provided by thread grinding process which has the same dimension as that of the full thread portion 16a and, thereafter, the outer circumferential portions indicated by the hatched areas are ground and removed by grinding processing using a cylindrical grinding stone. This allows the chamfer portion 16b to have a targeted screw thread configuration having the outer circumferential surfaces 26 formed in linear shapes along the axial direction. The outer circumferential surface 26 intersects the axis O at an inclined angle θ (see FIG. 2B), which is determined to fall in a range of −15°≦θ≦30′ when a side, decreasing in diameter toward the tap end is defined as positive (+). In the present embodiment, all of a large number of screw threads, circumferentially divided by the three spiral flutes 20, have the outer circumferential surfaces 26 subjected to grinding with a single grinding stone to be inclined at the same inclined angles θ. FIG. 1C and FIG. 2A are views of the cutting edges 22 (at rake surfaces) viewed along each spiral flute 20, each corresponding to a cross sectional shape involving the axis O, with each outer circumferential surface 26 having an inclined angle θ=0°. In addition, the outer circumferential surfaces 26 and the screw threads may have flanks provided with reliefs or escapements depending on needs, respectively.

With such a structure, the spiral tap 10 is fixedly mounted on a spindle of, for instance, a tapping machine or the like and, then, the chamfer portion 16b is advanced forward in lead feed, that is, advanced with 1 P by one turn to be screwed into a preliminarily prepared hole of a workpiece. This allows the large number of cutting edges 22 formed on the chamfer portion 16b to cut an internal thread, and chips are guided and discharged through the spiral flutes 20 to sites near the shank 12. FIG. 2C is a view illustrating cross-sectional shapes of the chips (cutting shapes of the cutting edges 22) obtained when the spiral tap 10 of the present embodiment is screwed into the preliminarily prepared hole 32 of the workpiece 30 for cutting the internal thread. Regions designated by encircled numerals 1 to 8 represent an order of cutting steps and the cross-sectional shapes of the chips. All of the chips extend in parallel to the axis O and have nearly fixed thickness dimensions in a widthwise direction (axial direction) while having the nearly same thickness dimensions.

With the spiral tap 10 of the present embodiment, the chamfer portion 16b has the external thread having the screw threads with the outer circumferential surfaces 26 inclined with respect to the axis O at the inclined angle θ. That is, the outer circumferential portions of the cutting edges 22, formed at ridge portions where the screw threads and the spiral flute 20 intersect each other, are inclined with respect to the axis O at the inclined angle θ. The inclined angle θ falls in a range of −15°≦θ≦30′. Therefore, the chips have stable helical shapes to be favorably discharged from the spiral flutes 20 externally, thereby suppressing the occurrence of chipping or breaking of the cutting edge due to the biting of the chips for thereby providing increased durability.

With the present embodiment, further, the chamfer portion 16b has the plural screw threads, contiguous in the axial direction, which have outer diameters that vary along a fixed chamfering gradient that is predetermined. The variations t1 and t2 in outer diameter are equal to each other, and the multiple cutting edges 22 present in the chamfer portion 16b have nearly equal cutting dimensions. That is, the chips are nearly equal in thickness. Therefore, all of the cutting edges 22 of the chamfer portion 16b provide the chips with stable helical shapes, and a discharging performance of the chip is further increased.

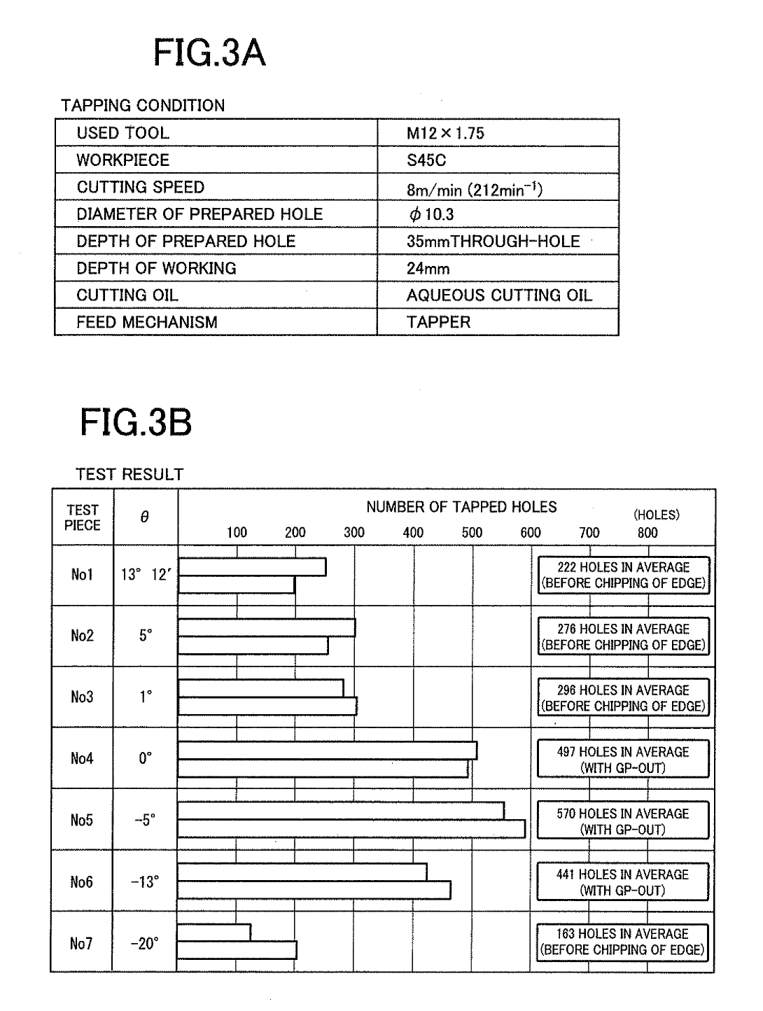

Durability tests were conducted for the spiral taps 10 of the present embodiment using test pieces Nos. 1 to 7 of seven kinds, each prepared by two pieces, which had the chamfer portions 16b including the screw threads with the outside diametric surfaces 26 formed at inclined angles θ which are different from each other. Test results were obtained as shown in FIGS. 3A-3C. The test pieces Nos. 1 to 7 of the seven kinds had different inclined angles θ as indicated in FIG. 3B. The test piece No. 1, having an inclined angle of θ=13°12′, represents a tool of the related art with the inclined angle θ determined to be equal to a chamfering gradient of the chamfer portion. The test pieces Nos. 4 to 6, having inclined angles θ ranging from 0° to −13°, represent tools of the present invention and the test pieces Nos. 2, 3 and 7 represent tools of comparative examples. Tapping of the internal threads i.e., female threads were conducted under a tapping condition shown in FIG. 3A for forming internal threads, and the numbers of tapped holes up to the endings of tool life causing the occurrence of chipping or gauge-out (GP-OUT) of edges were checked. Material “S45C” of a kind of the workpiece to be cut as indicated on FIG. 3A was carbon steel for machine structural use defined in JIS (Japanese Industrial Standards).

As will be apparent from the test result shown in FIG. 3B, all of the test pieces Nos. 4 to 6, implementing the present invention, had a capability of achieving tapping work until the test pieces encountered gauge-out due to wears of the cutting edges 22, upon which these test pieces were enabled to conduct the tapping to form 400 or more of internal threads. In contrast, all of the test pieces Nos. 1 to 3 and No. 7, having the inclined angles θ failing to fall in the range of −15°≦θ≦30′, reached the tool life because of the occurrence of chipping at the edges due to the biting of chips. In addition, all of these test pieces had an average number of tapped holes falling in a value of 300 or less. It further turns out that the products of the present invention can have durability improved by a value of approximately 40%.

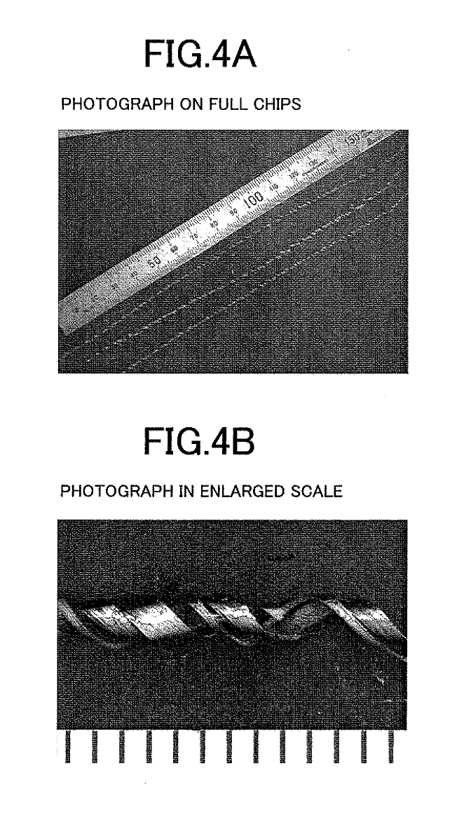

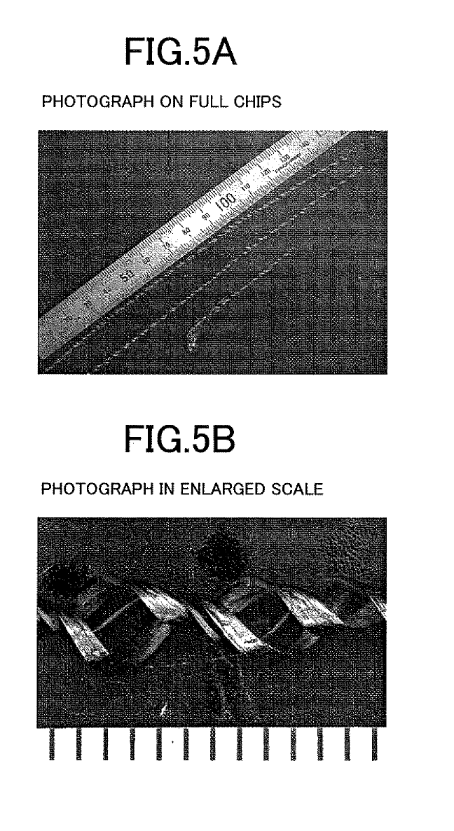

FIGS. 4A and 4B and FIGS. 5A and 5B are photographs showing cut ships discharged during tapping work for the durability tests. FIGS. 4A and 4B show chips discharged by the test piece No. 4 of the tap, implementing the present invention, and FIGS. 5A and 5B represents chips of the test piece No. 1 of the related art. As will be clearly seen from these photographs on the chips, the chips using the tap of the present invention, shown in FIGS. 4A and 4B, have relatively uniformly winding (helical) shapes. On the contrary, the chips using the tap of the related art, shown in FIGS. 5A and 5B, have shapes formed in a partially distorted winding shape and the presence of distorted winding shape causes a plurality of chips to intertwine with each other in the same spiral flute 20 accompanied by the occurrence of deterioration in discharging performance.

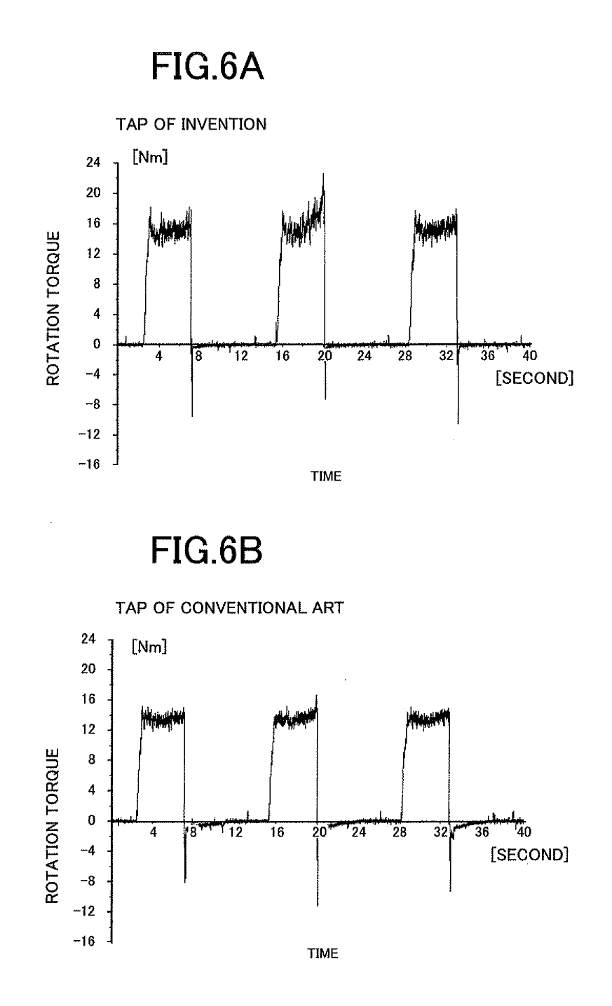

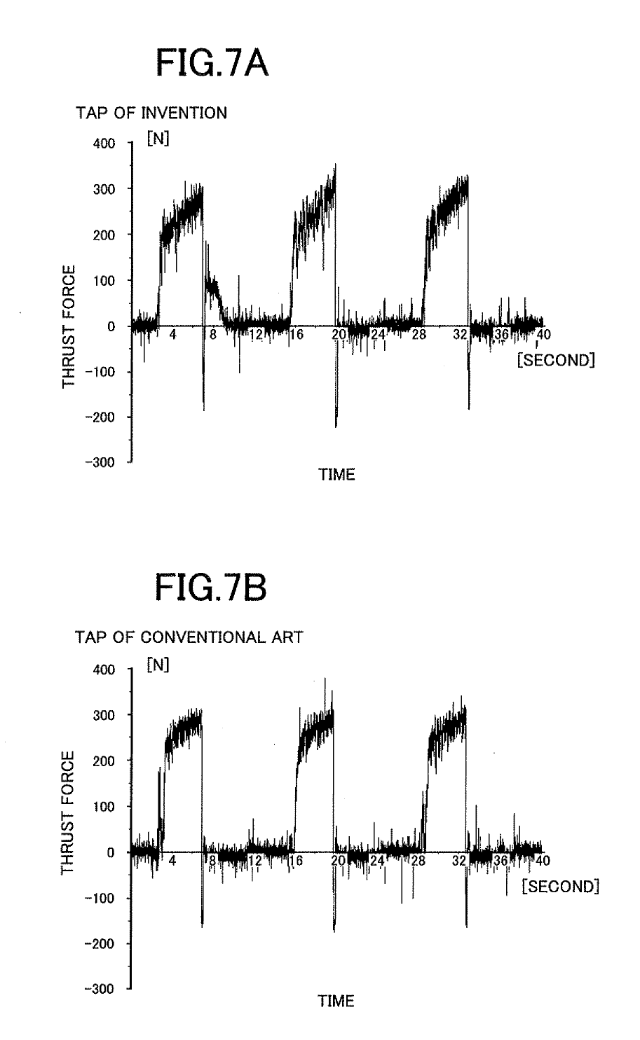

FIGS. 6A and 6B and FIGS. 7A and 7B show results on measured tapping torques (rotational torque) and thrust forces for initial three holes tapped during the durability tests conducted on the test piece No. 4 representing the tap of the present invention and the test piece No. 1 of the related art, which are used for the durability tests shown in FIGS. 3A and 3B. As shown in FIGS. 6A and 6B, although the test piece of the present invention had tapping torque slightly greater than that of the test piece of the related art, such tapping torque falls in an adequately allowable range for tapping. As to a thrust force shown in FIGS. 7A and 7B, almost no difference is present between those of the tap of the present invention and of the tap of the related art. As a result of such consequence, it turns out that the tap of the present invention provides the chip with the stable helical shape with increased discharging performance and durability, without almost no impairing of tapping torque and thrust force in contrast to those encountered in the tap of the related art.

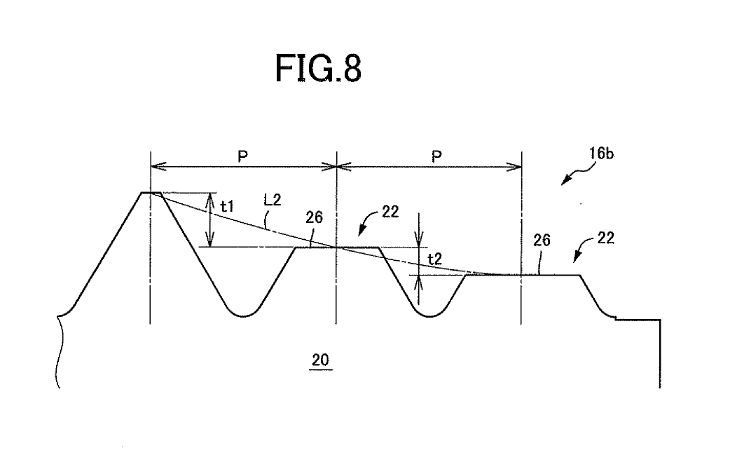

In the present embodiment set forth above, further, the chamfer portion 16b has a series of plural screw threads, contiguously formed in the axial direction, which have the outer circumferential surfaces 26 having the centers located on the linear line L1 so as to vary along the predetermined, fixed chamfering gradient such that the variations t1 and t2 in outer diameter are equaled to each other. However, the outer circumferential surfaces 26 may be varied such that the centers of the outer circumferential surfaces 26 are aligned on a concaved curve line L2 and the chamfer portion 16b formed in a concaved shape as shown in FIG. 8. In this case, the varying rate t2 in diametric dimension becomes less than t1 and a cutting dimension of the cutting edge 22, i.e., a thickness dimension of the chip decreases from the full thread portion 16a toward the tap end. With an area near the full thread portion 16a, neighboring tops of the screw threads perform the cutting, causing the chip to become small in width (corresponding to a width of the outer circumferential surface 26). With another area closer to the tap end, the cutting is performed with the screw thread in the vicinity of a root thereof, thereby causing the chip to become large in width. This allows cross-sectional shapes of the chips, generated by the individual cutting edges 22, to vary such that the cross-sectional areas (further volumes to be removed) of the chips are equalized to each other in comparison to a case where the chamfer portion varies at the fixed chamfering gradient as achieved in the previous embodiment mentioned above. This reduces a difference between cutting loads acting on the large number of cutting edges 22, thereby suppressing the occurrence of wear occurring on a localized area accompanied with resultant further increased durability.

With the embodiment shown in FIG. 8, the concaved shape, i.e., the concaved curve L2 may be determined such that the chips have cross-sectional surface areas nearly equal to each other and, under such a case, cutting loads acting on the large number of cutting edges 22 become nearly equaled to each other.

While the present invention has been described above with reference to the embodiments shown in the drawings, it is intended that the invention described be considered only as illustrative of the embodiments and that the present invention can be implemented in various modifications and improvements based on knowledge of those skilled in the art.

### INDUSTRIAL APPLICABILITY

With the spiral tap of the present invention, the chamfer portion is formed with the external thread having the screw threads that take the form of shapes obtained by cutting out the outer circumferential portions of the screw threads, having the same dimension as that of the full thread portion, on a linear line in cross section involving the axis O. The linear line intersects the axis O at the inclined angle θ in the range of −15°≦θ≦30′ wherein a side decreasing in diameter toward the tap end is defined to be positive. This allows the chips to be formed in the stable helical (spiral) forms to be favorably discharged from the spiral flutes to the outside. Further, this suppresses the occurrence of chipping of the cutting edge due to the biting of the chips to enable excellent durability to be obtained. Thus, the spiral tap can be preferably employed in tapping internal threads on various workpiece.

1. A spiral tap comprising:
a thread portion having an external thread, spiral flutes which is fluted in the same direction as a cutting/rotating direction, as seen in a direction away from a shank side, to divide the external thread, and cutting edges formed along the spiral flutes;
the thread portion including a full thread portion having a fixed outer diameter, and a chamfer portion decreasing in outer diameter toward a tap end;
the chamfer portion being screwed into a prepared hole to cut an internal thread on an inner circumferential wall of the prepared hole and to discharge chips along the spiral flutes toward the shank;
the chamfer portion having an external thread with screw threads which is formed such that outer circumferential portions are removed, at a linear line for cutting as seen from a direction perpendicular to a cross-section involving an axis O, from the screw threads having the same dimension as that of the full thread portion; and
the linear line intersecting the axis O at an inclined angle θ falling in a range of −15°≦θ≦30′ with a side decreasing in diameter toward the tap end being defined positive.

2. The spiral tap according to claim 1, wherein the chamfer portion has a plurality of screw threads, contiguous in the axial direction, which have outer diameters varying with a predetermined fixed chamfering gradient.

3. The spiral tap according to claim 1, wherein the chamfer portion has a plurality of screw threads, contiguous in the axial direction, which have outer diameters varying to have a concaved shape in the axial direction.
